(19) United States
(12) Patent Application Publication
(10) Pub. No.: US 2011/0078019 A1
(43) Pub. Date: Mar. 31, 2011

(54) SYSTEMS AND METHODS FOR RECEIVING VENDOR-SPONSORED ACCESS TO MEDIA CONTENT

(75) Inventor: Walter Richard Klappert, Los Angeles, CA (US)

(73) Assignee: Rovi Technologies Corporation, Santa Clara, CA (US)

(21) Appl. No.: 12/570,223

(22) Filed: Sep. 30, 2009

(51) Int. Cl. G06Q 30/00; G06Q 20/00; G06Q 50/00; G06F 15/16; G06F 12/14

(52) U.S. Cl. 705/14.51; 705/14.56; 705/14.69; 709/224; 726/29; 705/26.1

(57) ABSTRACT

Systems and methods for receiving vendor-sponsored access to media content are described. In these systems and methods, a consumer's access to media content is sponsored by vendors with whom the consumer has engaged in a transaction. This sponsorship may take the form of payments provided to a media provider for a media content item or service provided to the consumer. Consumers may access goods and services provided by vendors when they are interested in engaging in a transaction, and may be presented with transaction opportunities according to their preferences. Vendors may selectively target transaction opportunities to consumers and may only sponsor media access for consumers with whom they have completed a transaction.

### BACKGROUND OF THE INVENTION

Today's consumers may obtain access to a wide variety of media content (including video, audio, print and other content). In some systems, consumers typically access this content by paying a provider directly for the content (e.g., by paying a monthly bill for a fixed television cable service package or paying a per item fee for DVD rentals or movie downloads). Media content providers increase revenues (and may decrease the cost of content for consumers) by allowing vendors to advertise their goods and services alongside the media content (e.g., as a banner advertisement on a popular webpage). Some such media content providers may selectively “match” or target particular consumers to advertisements based on information about the consumer, such as past media content access and/or identification information such as age, gender or income. For example, an interactive slot machine may advertise a loan offer provided by a bank to a consumer who has run up a debt on the machine.

These existing approaches fail to satisfy the needs of many of the involved participants, including consumers, vendors and media providers. Consumers are often subject to advertisements for products and services that do not interest them and thus tend to ignore or avoid such advertisements. Vendors pay for these wasted advertisements, which do not result in successful transactions. Media providers have few mechanisms to encourage consumers to access additional media content. Additionally, new media access technologies such as DVR have allowed consumers to largely bypass traditional advertisements, which has reduced the amount a media provider may charge vendors for such advertisements. As a result, media providers have limited ability to promote their service as an advertising medium.

### SUMMARY OF THE INVENTION

Described herein are systems and methods for providing consumers with vendor-sponsored access to media content. In these systems and methods, a consumer's access to media content may be sponsored by vendors with whom the consumer has engaged in a transaction.

For example, described herein is an electronic system for managing vendor-sponsored access to media content which may include three participants: a media provider, a vendor and a consumer. The media provider may provide the consumer with access to media content. The cost of a portion of this media content access may be paid for by the vendor, in response to a transaction between the consumer and the vendor. For example, a consumer may purchase a good or service from a vendor (e.g., an item of athletic equipment from a sporting goods store), and in response, the vendor may pay a media provider for an item of media content for the consumer (e.g., an on-demand video or an audiobook download), or may pay for some or all of a periodic service charge assessed to the consumer (e.g., the consumer's monthly cable television bill).

Transactions between vendors and consumers may occur “within” the system (i.e., via an electronic communications pathway including the media provider). For example, the consumer may place an order for food delivery from a local restaurant through an interactive application provided by the consumer's cable television system. In response to this transaction, the local restaurant may sponsor the consumer's access to a premium service, such as a week's worth of membership in an online gaming site. Additionally, the system may allow a consumer to establish preferences for the form and content of transaction opportunities he or she would like to receive through the media provider. For example, one consumer may prefer to view traditional commercial advertisements, while another consumer may prefer to receive notification of special offers. The system may also include additional participants, such as a buyer and an owner, which may provide additional functionality to the system.

The systems and methods described herein address the drawbacks of existing systems as described above, and provide a number of additional beneficial features. Consumers are readily able to access the goods and services provided by vendors when they are interested in engaging in a transaction, and may be presented with transaction opportunities according to their preferences. Consumers are also able to obtain the additional media they desire by engaging in transactions through the system. Vendors are able to more selectively target transaction opportunities to consumers and only pay for transaction opportunities that result in completed transactions. Media providers enjoy the benefits of increased consumer demand for media content and increased revenues from vendors who are attracted by the system.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is a simplified diagram of an illustrative vendor-sponsored media delivery system;

FIG. 2 is a flow diagram of illustrative steps for configuring a consumer module;

FIG. 3 depicts an illustrative consumer information preferences configuration screen;

FIG. 4 is a flow diagram of illustrative steps for configuring a vendor module;

FIG. 5 is a flow diagram of illustrative steps for configuring a media provider module;

FIG. 6 is a flow diagram of illustrative steps for configuring an auxiliary module;

FIG. 7 is a flow diagram of illustrative steps for providing a transaction opportunity;

FIG. 8 depicts an illustrative media access request screen;

FIG. 9 depicts an illustrative comparison shopping information screen;

FIG. 10 is a flow diagram of illustrative steps for providing vendor-sponsored media access;

FIG. 11 is a simplified diagram of an illustrative user equipment device which may be included in a consumer module;

FIG. 12 is a simplified diagram of an illustrative media delivery system;

FIG. 13 depicts an illustrative display screen that may be used to provide media guidance;

FIG. 14 is a simplified diagram of an illustrative vendor-sponsored media delivery system including an owner module;

FIG. 15 is a simplified diagram of an illustrative vendor-sponsored media delivery system including a buyer module; and

FIG. 16 is a simplified diagram of an illustrative vendor-sponsored media delivery system including a number of subsystems.

### DETAILED DESCRIPTION OF THE EMBODIMENTS

As described above, consumers may enjoy many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), print content (e.g., books, magazines and newspapers), music and audio content (e.g., podcasts, records, CDs, etc.) and other types of media content. Multimedia content is also popular; as used herein, the term multimedia is defined as media and content that utilizes at least two different content forms, such as text, audio, still images, animation, video, and interactivity content forms. Multimedia content may be recorded, played, displayed or accessed by information content processing devices, such as computerized and electronic devices, but can also be part of a live performance. It will be understood that the invention embodiments that may be discussed herein in relation to media content are applicable to many types of content, such as video, audio and/or multimedia.

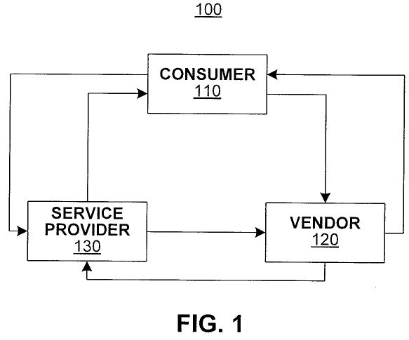

Media content may be provided to consumers by a media content provider. In the systems and methods described herein, a consumer's access to media content may be sponsored by one or more vendors as a result of transactions between the consumer and the vendors. FIG. 1 is a simplified diagram of an illustrative vendor-sponsored media delivery system 100 depicting three modules: consumer module 110, vendor module 120 and media provider module 130. These modules may be associated with a consumer, a vendor and a media provider, respectively.

In an embodiment, media provider module 130 may be in electronic communication with consumer module 110 and vendor module 120. Media provider module 130 may be configured to provide consumer module 110 with access to media content. Media provider module 130 may also be configured to receive an electronic communication from vendor module 120. This electronic communication may indicate the consumer associated with consumer module 110 and may be representative of the vendor's sponsorship of a portion of the cost of the electronic media content access provided to the consumer (via consumer module 110). For example, sponsorship by a vendor may include a payment towards a periodic service cost of the media content access provided to consumer module 110. Sponsorship by a vendor may include a payment for one or more items of media content provided to consumer module 110. In an embodiment, an electronic communication may be transmitted in response to a transaction between a vendor and a consumer. In an embodiment, a transaction between a vendor and a consumer may be the result of a transaction opportunity presented to the consumer by the media provider on behalf of the vendor.

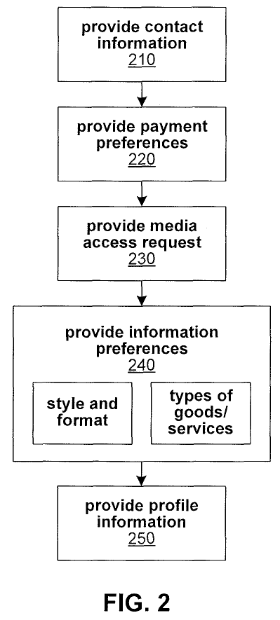

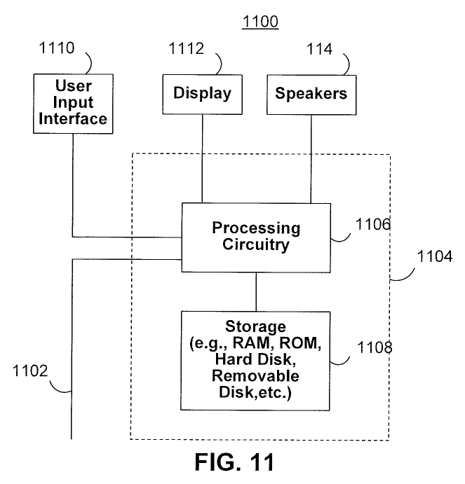

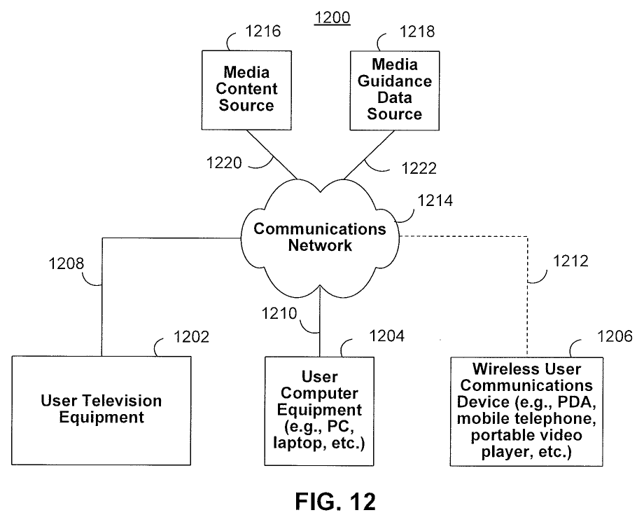

In an embodiment, consumer module 110, vendor module 120 and media provider module 130 may be suitable hardware devices capable of performing the functions described herein (e.g., the devices discussed below with reference to FIGS. 11 and 12). These modules may be communicatively coupled and configured to provide the functionality described herein. Illustrative embodiments of the initial configuration of modules such as consumer module 110, vendor module 120 and media provider module 130 will now be discussed with reference to FIGS. 2, 4 and 5. It will be understood that the steps described with reference to each of these figures may be performed in any suitable order, and that any one or more steps may be omitted or combined as suitable. Illustrative embodiments of the components used to implement the various modules described herein are discussed in additional detail below with reference to FIGS. 11 and 12. Any of the embodiments described herein may utilize secure data entry techniques, which may include both automated and manual techniques, to preserve the integrity and privacy of participants in the system, such as consumers, vendors and media providers.

FIG. 2 is a flow diagram of illustrative steps for configuring a consumer module (such as consumer module 110) within a vendor-sponsored media delivery system such as system 100 of FIG. 1. At step 210, contact information for a consumer may be provided. This information may include a consumer's physical location, which may determine the types of media content the consumer and/or the consumer module may be able to access. For example, a consumer's home address may be serviced by one or more cable television providers. Contact information may also include one or more ways of contacting the consumer (e.g., mobile device numbers, e-mail addresses, etc.). Such contact information may be used, for example, to alert a consumer to the presence of additional content or transaction opportunities, to deliver a billing statement, or to resolve technical issues with the consumer's access to media content.

At step 220, a consumer's payment preferences may be provided. In an embodiment, payment preferences may include whether or not a consumer would like to have the option to pay for media access if he or she has not obtained sufficient sponsorship via the transaction opportunities offered by the system (discussed in additional detail below). Step 220 may include providing billing information (such as credit card or bank account numbers) in the event that the consumer makes a payment to cover the cost of media access. In an embodiment, payment preferences may include a consumer preference for being automatically enrolled in one or more transaction opportunities to cover the cost of media access if he or she has not obtained sufficient sponsorship. For example, a consumer may opt to “turn on” commercial advertisements from a vendor or group of vendors (e.g., in a media guidance application running on one or more user devices) to cover the cost of media access. The term “credits” may be used herein to refer to a level of sponsorship of media access, which may be obtained by the consumer, for example, by engaging in transactions with one or more vendors, making payments, or being involved in any of a number of transaction opportunities as described herein. The term “credits” may refer to a monetary unit which may be exchanged for access to media items and/or services; a list of media items and/or services that have been sponsored for a consumer by one or more vendors; or a combination thereof.

At step 230, a consumer's media access request may be provided. A media access request may include many types of requests for media content; for example, a request for access to a package of cable television channels, a request for an Internet connection of a particular bandwidth, a request for audio or video files, a request for a subscription to a print publication, a request for an on-demand program, or a request for an audio or video media item to be mailed or picked-up at a local distribution point.

In an embodiment, media provider module 130 may provide vendor information content to consumer module 110. In such an embodiment, at step 240, a consumer's information preferences for vendor information may be provided. Information preferences may describe a consumer's preferences for different types of vendor information and the manner in which such information may be presented. In an embodiment, consumer information preferences may include a preference for the style and format with which advertisements are presented. For example, consumer information preferences may include a preference for at least one of traditional commercial advertisements, comparative purchase information, infomercial advertisements, and interactive advertisements. In an embodiment, consumer information preferences may include a preference for a transaction opportunity for at least one of a type of good and a type of service.

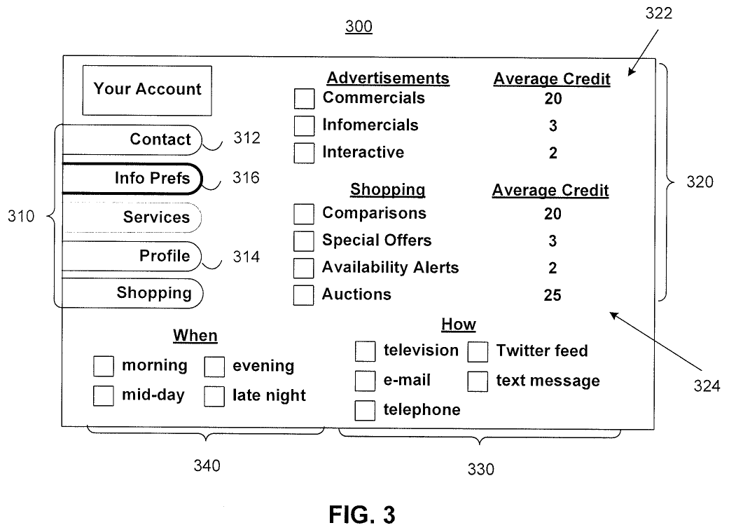

FIG. 3 depicts an illustrative consumer information preferences configuration screen 300. Such a configuration screen may be presented to a consumer by consumer module 110, or by a display communicatively coupled to consumer module 110. Illustrative screen 300 includes account categories region 310, format preferences region 320, communication preferences region 330 and timing preferences region 340. Account categories region 310 allows a consumer to select different categories of account information, such as contact information (via region 312) and profile information (via region 314). A screen displaying a category of account information may include information regarding the selected account category and may provide options which a consumer may configure within the selected account category. In illustrative screen 300, account category “Info Prefs” 316 may be highlighted to indicate that this is the account category which may be configured in screen 300.

Format preferences region 320 may include a consumer's preferences for the manner in which vendor information is to be provided to the consumer. For example, format preferences region 320 may include advertisements region 322 and shopping region 324, each of which allow a consumer to select one or more options for delivery of vendor information. In an embodiment, a consumer may rank such options, or may provide a qualitative indicator of preference such as “often” or “never”. For example, a consumer may indicate a primary preference for magazine articles discussing the item, and a secondary preference for information about the item's technical specifications. Format preferences region 320 may also include information about the average number of credits a consumer may earn by being presented with and/or engaging in transaction opportunities presented in different formats. In an embodiment, format preferences region 320 may include any type of information regarding the credit associated with one or more information formats, such as a typical range of credits, a maximum credit, and an option to view more detailed information regarding credits associated with an information format.

Communication preferences region 330 may allow a consumer to specify how vendor information and/or transaction opportunities may be communicated to him/her. Such modes of communication may include any type of suitable communication medium (e.g., e-mail messages, on-screen notifications, text messages, announcements in an audio stream, video advertisements in a video stream, etc). In an embodiment, selecting one or more communication preferences may allow a consumer to specify the details of such communication (e.g., a preferred e-mail address when “e-mail” is selected). As described above with reference to format preferences region 320, the options presented in communication preferences region 330 may also be ranked or indicated in a qualitative manner.

Illustrative screen 300 may also include timing preferences region 340, in which a consumer may specify preferences for the timing of transaction opportunities and/or vendor information. In an embodiment, a user may specify preferences for one or more of days of the week, times of day, and seasons (e.g., winter, college football season, sweeps weeks, etc.).

Returning to the flow diagram of FIG. 2, at step 250, a consumer's profile information may be provided. Profile information may include information about a consumer that may be used in the provision of transaction opportunities to the consumer from one or more vendors. At step 250, a consumer may specify additional information supplemental to the information provided at steps 210-240. For example, a consumer may specify one or more hobbies or leisure activities, a group to which the consumer belongs (e.g., a political party, a service organization, an athletic club), or a goal of the consumer (e.g., to purchase a home, take a vacation, or retire at a certain age). In an embodiment, consumer information may be provided to vendors by other means (e.g., based upon information provided at other steps in the flow diagram of FIG. 2). In an embodiment, profile information may be generated by the consumer module or a device in communication with the consumer module, based upon the consumer's access to media content, previous transactions, vendor information requests, or a combination thereof. In an embodiment, profile information provided in one or more steps of the flow diagram of FIG. 2 may be used by a buyer module as discussed in detail below.

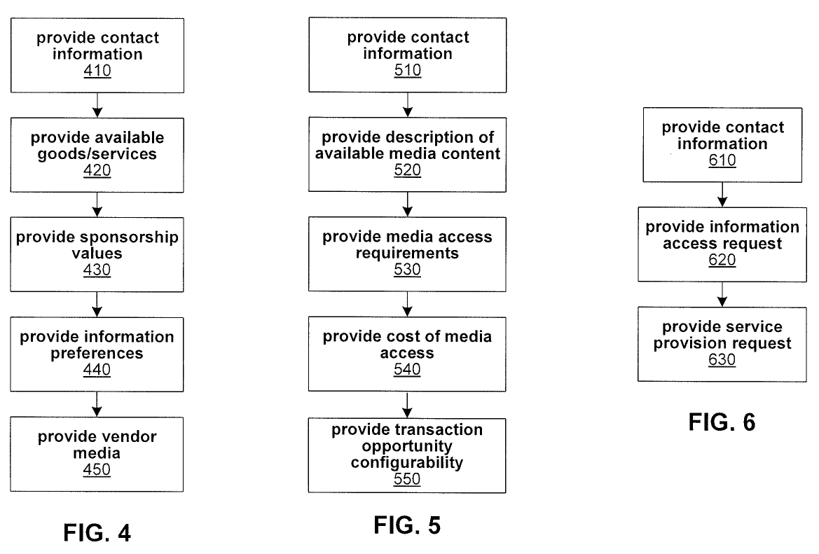

FIG. 4 is a flow diagram of illustrative steps for configuring a vendor module within a vendor-sponsored media delivery system. At step 410, contact information for a vendor may be provided. This information may include the vendor's physical location, which may determine a geographical extent to which the vendor's goods and/or services may be provided. For example, the location of a vendor's distribution facility may determine the cost of shipping goods to a consumer's location. Contact information may also include one or more ways of contacting the vendor (by a consumer and/or an administrator of the system), for example, a customer service or accounts department. Contact information for a vendor may also include tax information, protocols for handling vendor information content (discussed in detail below), and terms of agreement between participants within the system.

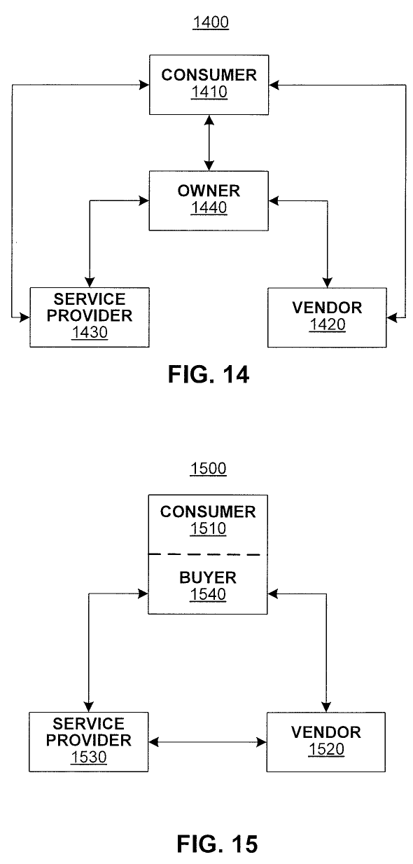

At step 420, a description of a vendor's available goods and/or services may be provided. In an embodiment, such a description is provided by vendor module 120, which may be communicably coupled to one or more additional modules as described herein. In an embodiment, vendor module 120 may provide information content to media provider module 130. In an embodiment, vendor module 120 may provide information content to an owner module, as described in detail below with reference to FIG. 14. In an embodiment, a description may be provided at step 420 manually by a vendor representative or may be provided in batch form (e.g., via a data file). The description may include any one or more of: a list of available goods and/or services, a cost to the consumer for each good and/or service, detailed information regarding each good and/or service, delivery constraints for each good and/or service, and a targeted consumer type for each good and/or service. For example, a snow removal service offered by a vendor of landscape services may be indicated as targeted towards consumers in colder climates, while a tree planting service may be indicated as targeted towards consumers interested in purchasing a new home.

At step 430, sponsorship values associated with each available good and/or service may be provided. These sponsorship values indicate the media content access which a consumer will earn by agreeing to purchase the available good and/or service. In an embodiment, a sponsorship value may be a number of credits which a user may apply toward one or more types of media access (e.g., as illustrated in FIG. 3, described above). In an embodiment, a sponsorship value may be a specific item of media content or type of media content access, such as a coupon for two DVD rentals or a month of membership in a music club. In an embodiment, sponsorship values of one or more of the available goods and/or services may be linked. For example, a consumer may receive two free VOD downloads for watching one of a vendor's infomercials, but may receive five free VOD downloads for watching two of a vendor's infomercials. In an embodiment, sponsorship values may indicate one or more media providers capable of providing sponsored media. For example, in exchange for purchasing a membership at a fitness club, a consumer may receive a download of a mobile device application focused on nutritious eating or access to a television channel which provides exercise programs.

At step 440, a vendor's information preferences may be provided. As described above with reference to consumer information preferences at step 240 of FIG. 2, such preferences may include a vendor's preferences for the manner in which information regarding the vendor's available goods and/or services may be presented (e.g., as a transaction opportunity). In an embodiment, a vendor may indicate a preference for different types and items of media content to associate with the vendor's available goods and/or services. For example, a Porsche dealer may specify that Porsche transaction opportunities be presented alongside movies which feature Porsche automobiles, or when a user is watching a channel dedicated to automobile programming. In an embodiment, a vendor may indicate a preference for a season, day or time for presenting transaction opportunities.

At step 450, vendor media content may be provided. Vendor media content may include any media content used to advertise a vendor's goods and/or services, or provide or describe a transaction opportunity. For example, a skateboard vendor may provide video clips of famous skateboarders performing tricks on the skateboards sold by the vendor. In another example, an electronics vendor may provide technical specifications of a microprocessor offered for sale, or provide articles describing how to use the microprocessor in different circuit applications. In another example, a vendor may provide an advertising jingle or slogan that may be included in a media guidance application presented on a consumer module (e.g., consumer module 110 of FIG. 1.

FIG. 5 is a flow diagram of illustrative steps for configuring a media provider module within a vendor-sponsored media delivery system. At step 510, contact information for a media provider may be provided. This information may include the media provider's physical location, which may determine a geographical extent to which the media provider may provide media access. For example, a cellular telephone content distributor may only be able to provide content to users within a particular geographic area centered on one or more cellular base stations. Contact information may also include one or more ways of contacting the media provider (by a consumer and/or an administrator of the system), for example, a customer service or accounts department. Contact information for a media provider may also include tax information, protocols for handling vendor-provided content, and terms of agreement between participants within the system.

At step 520, a description of a media provider's available media content may be provided. In an embodiment, such a description is provided to a media provider module, which may be communicably coupled to one or more additional modules as described herein. In an embodiment, a description may be provided at step 520 manually by a media provider representative or may be provided in batch form (e.g., via a data file). The description may include: a list of available media items and/or services, detailed information regarding each good and/or service, or a combination thereof.

In an embodiment, a media provider may provide media content according to a schedule. Such content may be referred to as “linear” content; examples include a broadcast television channel, a satellite radio station, and a weekly print journal. In addition or alternatively to providing access to linear content provided according to a schedule, a media provider may provide access to non-linear content which may not be provided according to a schedule. Non-linear content may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), print content (e.g., books, past issues of magazines) or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g., FTP).

Returning to FIG. 5, at step 530, requirements for accessing media content may be provided. Such requirements may include technical requirements on a consumer's user equipment which may be included in consumer module 110. For example, high-definition (HD) television service may only be provided to a consumer with a television receiver capable of interpreting HDTV signals. In another example, a media provider may restrict the provision of R-rated DVDs to consumers over 17 years of age. In an embodiment, requirements provided at step 530 may be presented to a consumer as options from which a consumer can choose. For example, a media provider may offer a streaming video to all consumers, but specify that the streaming video be recommended only to consumers with Internet connections that exceed a specified bandwidth. In such an embodiment, a media provider may offer an alternate type or format of the media content to users of systems with different capabilities.

At step 540, costs of media access may be provided. These costs may represent the amount a media provider wishes to be paid for particular items of media content or particular services. In an embodiment, the cost to the media provider for each media item and/or service may depend upon the particular consumer receiving the media item and/or service. In an embodiment, the cost may depend on the user equipment included in consumer module 110 used to access the media content from media provider module 130 of FIG. 1. For example, a provider of streaming media for cellular phones may charge one rate for users of a particular cellular phone service and a different rate for users of a different cellular phone service. In an embodiment, the cost of one or more media content items may depend on other media accessed by the consumer from the media provider. For example, a media provider may offer one or more subscription packages to consumers, which may bundle multiple items of media content or multiple media services (e.g., a magazine subscription and access to a related website).

At step 550, transaction opportunity configurability information is provided. Transaction opportunity configurability refers to any manner in which the media provider may provide transaction opportunities and/or vendor information to consumers. For example, a print media provider may offer to run full-page magazine advertisements for vendors associated with the system. In another example, a television service provider may offer banner advertisement space in a media guidance application. In another example, an Internet radio provider may offer graphic advertisement space or audio “spots” in which transaction opportunities and/or vendor information may be provided. Media provider module 130 may retain a database of configurability information.

Configurability information may also be provided by a media provider to vendors (e.g., via electronic communication between media provider module 130 and vendor module 120 of FIG. 1). In turn, vendors associated with system 100 may indicate a preference for one or more of the available transaction opportunity configurations offered by one or more media providers associated with system 100. In an embodiment, vendor-provided content (such as the content provided at step 450 of FIG. 4) may be matched to one or more transaction opportunity configurations offered by one or more media providers. This matching may be performed by media provider module 130, which may receive the vendor-provided content directly from a vendor (e.g., by communicating with vendor module 120 of FIG. 1) or from a central source such as an owner module, described in detail below. Matching of vendor-provided content with media provider transaction opportunity configurations may be performed in accordance with known scheduling and matching techniques.

Additional participants may be included in a vendor-sponsored media delivery system, such as system 100 of FIG. 1. FIG. 6 is a flow diagram of illustrative steps for configuring an auxiliary module within a vendor-sponsored media delivery system. An auxiliary module may represent any participant in system 100 that may not be readily classified as a consumer, vendor or media provider. For example, an auxiliary module may represent a technical service that provides troubleshooting and repair of the hardware and/or software which delivers media content from a media provider to a consumer. An auxiliary module may represent a research organization, which may collect information regarding the activities of consumers, vendors and media providers within system 100. An auxiliary module may represent an auditing or accounting body, responsible for maintaining records of the activities of participants in system 100 for tax or other purposes. An auxiliary module may represent any participant who may seek information regarding the activities of system 100, contribute to the activities of system 100, or a combination thereof.

At step 610, contact information for an auxiliary participant may be provided. This information may include any of the contact information items described above with reference to steps 210, 410 and 510 of FIGS. 2, 4 and 5, respectively, including physical location, one or more ways of contacting the auxiliary participant, and terms of agreement between the auxiliary participant and other participants within the system.

At step 620, an information access request may be provided by the auxiliary participant. An information access request may include a request for information about one or more consumers in system 100, one or more vendors in system 100, one or more media providers in system 100, or a combination thereof. For example, a research organization interested in television viewing patterns may request information regarding which television programs (e.g., provided by media provider module 130) were watched most often by consumers (e.g., via consumer module 110). In another example, a consulting company seeking to improve a user interface of system 100 may request information regarding the average amount of time one or more consumers or vendors spend on a particular configuration screen (e.g., consumer information preferences configuration screen 300).

At step 630, a service provision request may be provided. A service provision request may include a description of one or more services the auxiliary participant may be interested in providing to other participants in system 100. For example, a bank may wish to offer loans to consumers who are unable to engage in sufficient transaction opportunities to cover the cost of their media access. It will be noted that a bank may also be configured as a vendor within system 100, as suitable.

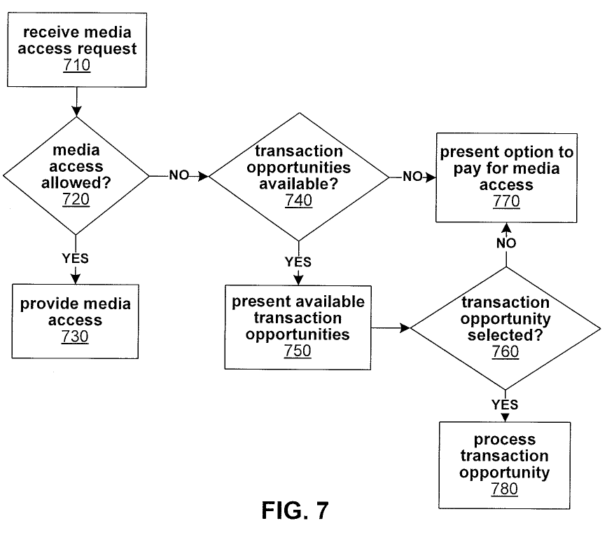

The configuration information provided by the consumer, vendor, media provider and auxiliary participants (e.g., as illustrated in the flow diagrams of FIGS. 2 and 4-6) may be used to enable a number of functions of vendor-sponsored media access system 100. Illustrative embodiments of such functions are discussed below. FIG. 7 is a flow diagram of illustrative steps for providing a transaction opportunity. It will be understood that the order and number of steps depicted in FIG. 7 is purely illustrative, and that any suitable steps may be performed in any suitable order as described herein. It will also be understood that each of the steps may be performed by any suitably configured hardware, elements of which may be communicably coupled by any of a number of networking schemes (e.g., via a single hardware BUS, a wireless communications network, a combination of wired and wireless network components, etc.). Illustrative embodiments of systems capable of implementing the processes described herein are discussed below with reference to FIGS. 11 and 12.

At step 710, a media access request may be received. A media access request may represent an indication by a consumer that a particular item of media content or a media service is desired. The media access request may be transmitted by consumer module 110 of FIG. 1, and may be transmitted to a media provider or to an owner (described in detail below).

At step 720, the media access request may be evaluated to determine whether the requested media access may be allowed. The determination at step 720 may be based on a number of factors, including information about a consumer's account (e.g., a balance of credits, a history of late payments, a geographic constraint, or a hardware/software constraint), and information about the requested media (e.g., the media provider's available bandwidth or limitations on the number of simultaneous connections). In an embodiment, media provider module 130 may be configured to provide an outstanding cost of the media content access based on a maintained record. In an embodiment, the cost of a media access request may be compared to the available credits in a consumer's account at step 720. If the available credits cover the cost of the requested media, media access may be provided at step 730.

In an embodiment, if the available credits in a consumer's account does not cover the cost of the requested media, system 100 may determine whether any transaction opportunities are available to be presented to the consumer at step 740. This determination may be performed by any suitable participant in system 100, and may involve communication between multiple participants (e.g., vendor module 120 and media provider module 130 of FIG. 1). Such transaction opportunities may provide additional credits which the user may apply toward the media access requested at step 720 (or another, future request). In an embodiment, a consumer may adjust the media content access provided to consumer module 110 based at least in part on an outstanding cost of media access. In an embodiment, if the available credits in a consumer's account do not cover the cost of the requested media, the consumer may be presented with an option to request alternate media content and/or services which may be covered by the available credits. Alternate media content and/or services may be related to the media access requested at step 710, for example, by type or content (e.g., an SD format presented as an alternative to an HD format, or previous seasons of a television program presented as an alternative to a current season).

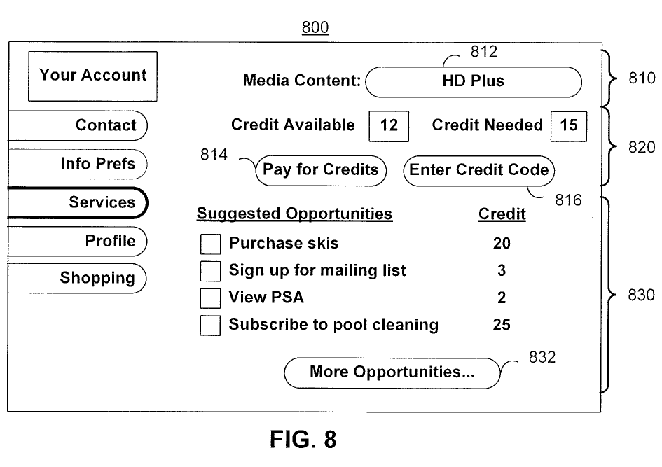

If transaction opportunities for the consumer are available (as determined at step 740), these transaction opportunities may be presented at step 750. FIG. 8 depicts an illustrative media access request screen 800, which may be presented to a consumer to guide him or her through one or more of the steps of the flow diagram of FIG. 7. Screen 800 includes media access request region 810, credits information region 820, and transaction opportunities region 830. Media access request region 810 may allow a consumer to provide a request for media access (as described with reference to step 710 of FIG. 7), for example, by activating region 812 and further selecting from a menu of possible media items and/or services. In an embodiment, a media access request may be provided by selecting an icon or message advertising a media content item displayed while viewing another media item, by selecting an icon or message displayed while viewing a media guidance application (discussed in detail below), and/or by entering a pre-defined code or instruction (e.g., a code, printed in a magazine, representing an on-demand movie).

Credits information region 820 of screen 800 may include information regarding the credits available to a consumer to be applied toward a media access request. In an embodiment, a surplus or deficit in a consumer's available credits may be displayed with respect to the media access requested (as represented in media access request region 810). Credits information region 820 may display whether or not media access may be provided as determined at step 720 (e.g., by displaying the service package “HD Plus” in a green typeface if access is allowed or in a red typeface if access is denied). In an embodiment, areas within credits information region 820 may be selected to display detailed information. For example, selecting “Credit Needed” may display a screen presenting the number of credits required for each of the media content items and/or services requested, and may allow a consumer to adjust his or her media access request.

In an embodiment, a consumer may be allowed to pay for credits to cover the cost of his or her media access, alternatively to or in conjunction with credits earned by engaging in transaction opportunities with vendors in system 100. For example, a consumer may select button 812, which may initiate a payment based at least in part on some of the contact information provided at step 210 and payment preferences provided at step 220 of the flow diagram of FIG. 2. In an embodiment, a consumer may be able to enter a credit code or other authorization to redeem credits or obtain access to media content (e.g., by selecting button 814 of FIG. 8). Such a credit code may be provided, for example, by a vendor in response to a transaction completed outside of the transaction monitoring capabilities of system 100. Credit codes may allow vendors to participate in system 100 without requiring electronic or automated monitoring of the vendor's transactions (e.g., for transactions that occur “offline”).

Transaction opportunities region 830 of screen 800 may include transaction opportunities in which the consumer may engage to increase the credits available in his or her account. The transaction opportunities presented in region 830 may be selected in any of a number of ways, and may depend on, for example, the consumer's geographic location, hardware/software constraints, previous transaction opportunities, profile information, information preferences, credits needed to cover the media access request, or any combination thereof. In an embodiment, transaction opportunities region 830 may include information regarding the credits that may be obtained by engaging in each of the displayed transaction opportunities. In an embodiment, each of the displayed transaction opportunities may be selected by a consumer to access more detailed information regarding the transaction opportunity (e.g., the schedule, cost and restrictions of a housekeeping service). In an embodiment, a consumer may indicate a desire to receive additional transaction opportunities (e.g., by selecting “More Opportunities” button 832).

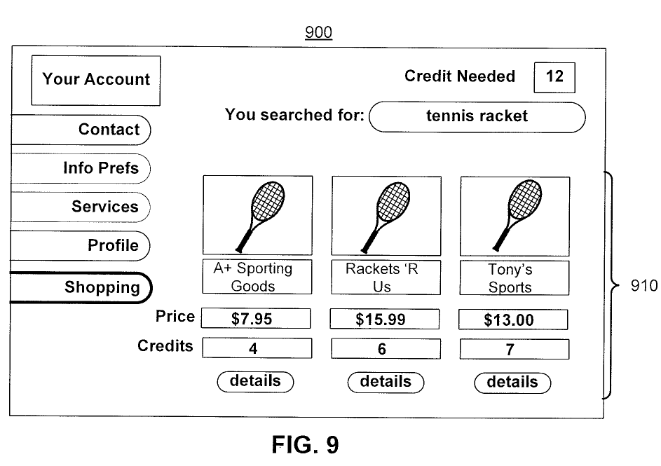

As described above, transaction opportunities may include any of a variety of interactions between vendors and consumers, and consumers may specify the ways in which they prefer to receive information regarding such transaction opportunities. In an embodiment, vendor information content provided to consumers may include content from multiple vendors, each associated with a vendor module such as vendor module 120 of FIG. 1. In an embodiment, a transaction opportunity may be presented to a consumer in a comparison shopping format. FIG. 9 depicts an illustrative comparison shopping information screen 900. An example that illustrates one use of such a screen is as follows. A consumer may be interested in purchasing a tennis racket, and may request such information by submitting a search query “tennis racket” within a “Shopping” category of account information. In an embodiment, a search query may be input directly by a consumer or may be a suggested transaction opportunity presented in transaction opportunities region 830 of media access request screen 800 of FIG. 8. In an embodiment, screen 900 displays information regarding the credits needed to cover the cost of any media access requested. Such information may be displayed on each of multiple transaction opportunity screens to aid a consumer's transaction opportunity decisions. Screen 900 may include a comparison region 910 which may display one or more items and/or services related to the search query and available from one or more vendors. As shown, comparison region 910 may also include credit information detailing the number of credits a consumer may receive by engaging in an associated transaction.

In an embodiment, transaction opportunities may be presented to a consumer in an auction format. In such a format, consumers may bid competitively with other consumers for goods and/or services provided by vendors associated with the system. In an embodiment, a transaction opportunity may take the form of a call for proposals, in which a consumer specifies a good and/or service which he or she would like to purchase, and vendors associated with the system may competitively bid to provide the specified good and/or service. Such functions may be implemented in accordance with known consumer/vendor auction techniques.

Returning to the flow diagram of FIG. 7, at step 760, system 100 may determine whether the consumer has selected one or more transaction opportunities. If no transaction opportunities have been selected, the consumer may, at step 770, be presented with the option to pay for the media access requested at step 710. The option to pay for the media access requested may also be presented to the consumer if it is determined that no transaction opportunities are available at step 740. In an embodiment, a consumer may also be presented with the option to pay for media access prior to determining whether any transaction opportunities are available at step 740. For example, a user may select button 814 in illustrative screen 800 of FIG. 8.

If it is determined, at step 760, that a user has selected one or more transaction opportunities, these transaction opportunities may be processed at step 780. In an embodiment, processing a transaction opportunity may include directing a consumer to contact a vendor to confirm and/or complete the associated transaction. In an embodiment, processing a transaction opportunity may include facilitating the transaction between the consumer and the vendor (e.g., by arranging for billing, shipping and/or scheduling of the transaction). In an embodiment, a transaction opportunity may be accepted by the consumer via consumer module 110. In an embodiment, media provider module 130 may record an accepted transaction opportunity between the vendor and the consumer. In an embodiment, media provider module 130 may communicate the accepted transaction opportunity to vendor module 120, in response to which the vendor may complete the transaction with the consumer.

In an embodiment, processing a transaction opportunity may include providing an item of media content from a media content provider, for example, when the selected transaction opportunity is the viewing of a public service announcement sponsored by a vendor (e.g., a government agency or community organization). In an embodiment, a transaction opportunity may be processed at step 780 via a buyer module, described in detail below. In an embodiment, a transaction opportunity may be provided at step 780 via an owner module, described in detail below.

In an embodiment, a consumer may request transaction opportunities without first requesting media access. As described above with reference to FIG. 9, system 100 may serve as a “pull” system for transaction opportunities, in which a consumer may request transaction opportunities, rather than having advertisements and commercials “pushed” to him or her. In an embodiment, vendor information content may be provided in response to a consumer information request transmitted to media provider module 130 by consumer module 110 of FIG. 1. In an embodiment, a transaction opportunity may be provided in response to a consumer transaction opportunity request, transmitted by consumer module 110.

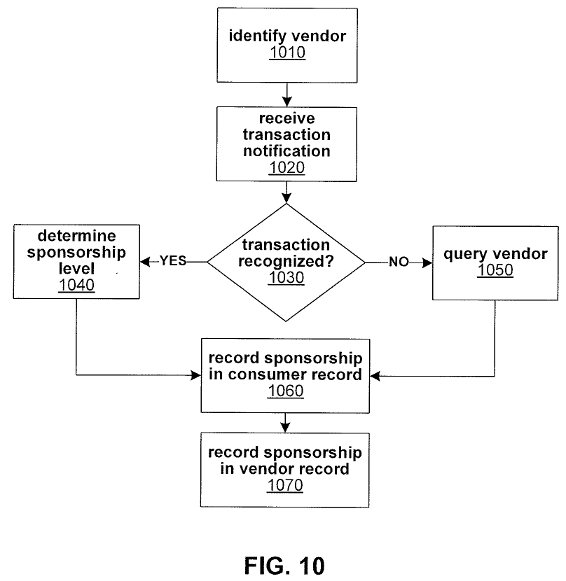

In the discussion of FIG. 7 above, illustrative steps for responding to a consumer's request for media access are described. In an embodiment, several of these steps may be based at least in part on the credits available in a consumer's account. These credits may arise from direct payments by the consumer, or as described above, may arise from vendor sponsorship resulting from transactions between the consumer and the vendor. FIG. 10 is a flow diagram of illustrative steps for providing vendor-sponsored media access. The flow diagram of FIG. 10 is described below with respect to a database of system 100 of FIG. 1 which maintains information regarding the credits associated with a consumer's account and is configured to update this information in response to information regarding transactions between vendors and consumers. Such a database may be maintained by any suitable participant within system 100. Illustrative embodiments of databases suitable for maintaining this information are described below with reference to FIGS. 11, 12 and 16.

At step 1010, a vendor may be identified. A vendor may be identified by supplying an associated vendor identification number, or may be identified by use of a particular vendor module configured to communicate identification information (e.g., having a particular IP address). At step 1020, a transaction notification may be received, transmitted from the vendor identified at step 1010. A transaction notification may include information regarding a transaction between the vendor and a consumer, which may have a status (e.g., anticipated, pending, completed or disputed). In an embodiment, steps 1010 and steps 1020 are combined by communicating a message from vendor module 120 including vendor identification information and transaction information. It will be recognized that, in accordance with an embodiment, suitable steps of the flow diagram of FIG. 10 may be performed by consumer module 110 instead of or in addition to vendor module 120.

At step 1030, the transaction notification received at step 1020 may be examined to determine whether the associated transaction is recognized. A recognized transaction may be one for which system 100 is able to identify all involved participants, properly increment or decrement credits in a consumer's account, provide any associated media access, or any combination thereof. If the transaction is recognized at step 1030, the sponsorship level of the vendor for media access by the associated consumer may be determined at step 1040. For example, the sponsorship level may include a number of credits by which to increment a consumer's account. In another example, the sponsorship level may include an indication of an on-demand movie to which a consumer may receive access. In another example, the sponsorship level may include a subscription to a magazine. In an embodiment, a sponsorship level determined at step 1040 may decrease the number of credits available in a consumer's account, or withdraw sponsorship of access to media content. A withdrawal of sponsorship may be triggered, for example, by a canceled transaction between a vendor and a consumer.

If the transaction is not recognized at step 1030, the vendor may be queried at step 1050. A query of a vendor may include a request for retransmission of a portion of the transaction notification or additional information. A vendor query may be transmitted electronically to a vendor module (e.g., by an e-mail notification or an alert message on a vendor account screen for an Internet-based system) and may include a telephone call or postal letter. In an embodiment, a consumer may be queried at step 1050 instead of or in addition to the vendor.

At step 1060, the vendor sponsorship may be recorded in a consumer record. The consumer record of vendor sponsorship may be used to determine the media content and/or services to which the consumer may gain access. As described above, such records may be stored in a suitable database associated with system 100. At step 1070, the vendor sponsorship may be recorded in a vendor record. A vendor record of vendor sponsorship may be used to determine payments that may be made by the vendor to a suitable participant to cover the cost of a consumer's media access at the level of the recorded sponsorship. In an embodiment, these payments may be made by a vendor directly to a media provider. In an embodiment, these payments may be made by a vendor to an owner (described in detail below), who may in turn make payments to one or more media providers. In an embodiment, system 100 may record the sponsorship in a database which is communicably coupled to one or more of a consumer module, a vendor module and a media provider module.

In an embodiment of the systems and methods for vendor-sponsored access to media content described herein, a vendor may provide sponsorship of a specific consumer's access to media content in response to engaging in a transaction with that specific consumer. Such an embodiment is distinct from traditional media advertising, in which vendors pay to place advertisements in anticipation of future transactions, which may or may not occur. Additionally, payments made by vendors for traditional advertisements have not sponsored a specific consumer's access to media as described herein.

Several illustrative embodiments of hardware and software components which may be used to implement system 100 (FIG. 1) will now be discussed. In particular, system 100 will be described in the context of an electronic media delivery system. It will be understood that such embodiments are illustrative, and that the systems and methods described herein may be applied to any suitable media delivery systems which may incorporate vendor-sponsored media access, including print media and audio and video media transmitted non-electronically (e.g., by postal mail).

FIG. 11 is a simplified diagram of an illustrative user equipment device 1100 which may be included in a consumer module (such as consumer module 110). With the advent of the Internet, mobile computing, and high-speed wireless networks, consumers are accessing media on personal computers (PCs) and other devices on which they traditionally did not, such as hand-held computers, personal digital assistants (PDAs), mobile telephones, or other mobile devices. Media may be provided through on-line applications (i.e., provided on a website), or as stand-alone applications or clients on hand-held computers, PDAs, mobile telephones, or other mobile devices. Various devices and platforms that may implement media delivery and guidance applications are described in more detail below.

Consumers may access media content and media guidance applications from one or more of their user equipment devices. FIG. 11 shows a generalized embodiment of illustrative user equipment device 1100. More specific implementations of user equipment devices are discussed below in connection with FIG. 12. User equipment device 1100 may receive media content and data via input/output (hereinafter “I/O”) path 1102. I/O path 1102 may provide media content (e.g., broadcast programming, on-demand programming, Internet content, and other text, video or audio) and data to control circuitry 1104, which may include processing circuitry 1106 and storage 1108. Control circuitry 1104 may be used to send and receive commands, requests, and other suitable data using I/O path 1102. I/O path 1102 may connect control circuitry 1104 (and specifically processing circuitry 1106) to one or more communications paths (described below). I/O functions may be provided by one or more of these communications paths, but are shown as a single path in FIG. 11 to avoid overcomplicating the drawing.

Control circuitry 1104 may be based on any suitable processing circuitry 1106 such as processing circuitry based on one or more microprocessors, microcontrollers, digital signal processors, programmable logic devices, etc. In some embodiments, control circuitry 1104 may execute instructions for a media guidance application stored in memory (e.g., storage 1108). In client-server based embodiments, control circuitry 1104 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (described in more detail below with reference to FIG. 12). In addition, communications circuitry may include circuitry that enables peer-to-peer communication between user equipment devices, or communication between user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 1108 that may be part of control circuitry 1104. Storage 1108 may include one or more of the above types of storage devices. For example, user equipment device 1100 may include a hard drive for a DVR (sometimes called a personal video recorder, or PVR) and a DVD recorder as a secondary storage device. Storage 1108 may be used to store various types of media described herein and guidance application data, including program information, guidance application settings, user preferences or profile information, or other data used in operating the guidance application. Nonvolatile memory may also be used (e.g., to launch a boot-up routine and other instructions).

Control circuitry 1104 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 1104 may also include scaler circuitry for upconverting and downconverting media into the preferred output format of user equipment 1100. Circuitry 1104 may also include digital-to-analog converter circuitry and analog-to-digital converter circuitry for converting between digital and analog signals. The tuning and encoding circuitry may be used by user equipment 1100 to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 1108 is provided as a separate device from user equipment 1100, the tuning and encoding circuitry (including multiple tuners) may be associated with storage 1108.

A user may control the control circuitry 1104 using user input interface 1110. User input interface 1110 may be any suitable user interface, such as a remote control, mouse, trackball, keypad, keyboard, touch screen, touch pad, stylus input, joystick, voice recognition interface, or other user input interfaces. Display 1112 may be provided as a stand-alone device or integrated with other elements of user equipment device 1100. Display 1112 may be one or more of a monitor, a television, a liquid crystal display (LCD) for a mobile device, or any other suitable equipment for displaying visual images. For example, display 1112 may be capable of displaying any of the illustrative screens described herein, including those of FIGS. 3, 8, 9 and 13. In some embodiments, display 1112 may be HDTV-capable. The audio component of videos and other media content displayed on display 1112 may be played through speakers 1114. Speakers 1114 may be provided as integrated with other elements of user equipment device 1100 or may be stand-alone units. In some embodiments, the audio may be distributed to a receiver (not shown), which processes and outputs the audio via speakers 1114.

User equipment device 1100 of FIG. 11 can be implemented in system 1200 of FIG. 12 as user television equipment 1202, user computer equipment 1204, wireless user communications device 1206, or any other type of user equipment suitable for accessing media, such as a non-portable gaming machine. For simplicity, these devices may be referred to herein collectively as user equipment or user equipment devices. A user equipment device, on which a media guidance application may be implemented, may function as a standalone device or may be part of a network of devices. Various network configurations of devices may be implemented and are discussed in more detail below.

User television equipment 1202 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 1204 may include a PC, a laptop, a tablet, a WebTV box, a personal computer television (PC/TV), a PC media server, a PC media center, or other user computer equipment. WEBTV is a trademark owned by Microsoft Corp. Wireless user communications device 1206 may include a PDA, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 1202, user computer equipment 1204, and wireless user communications device 1206 may utilize at least some of the system features described above in connection with FIG. 11 and, as a result, include flexibility with respect to the type of media content available on the device. For example, user television equipment 1202 may be Internet-enabled, allowing for access to Internet content, while user computer equipment 1204 may include a tuner allowing for access to television programming. A media guidance application may have the same layout on the various different types of user equipment or may be tailored to the display capabilities of the user equipment. For example, on user computer equipment 1204, a guidance application may be provided as a web site accessed by a web browser. In another example, a guidance application may be scaled down for wireless user communications devices.

In system 1200, there is typically more than one of each type of user equipment device but only one of each is shown in FIG. 12 to avoid overcomplicating the drawing. In addition, each consumer may utilize more than one type of user equipment device (e.g., a consumer may have a television set and a computer) and also more than one of each type of user equipment device (e.g., a consumer may have a PDA and a mobile telephone and/or multiple television sets).

User equipment devices may be coupled to communications network 1214. Namely, user television equipment 1202, user computer equipment 1204, and wireless user communications device 1206 may be coupled to communications network 1214 via communications paths 1208, 1210, and 1212, respectively. Communications network 1214 may be one or more networks including the Internet, a mobile phone network, mobile device (e.g., Blackberry) network, cable network, public switched telephone network, or other types of communications network or combinations of communications networks. BLACKBERRY is a service mark owned by Research In Motion Limited Corp. Paths 1208, 1210, and 1212 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Path 1212 is drawn with dotted lines to indicate that in the exemplary embodiment shown in FIG. 12 it is a wireless path and paths 1208 and 1210 are drawn as solid lines to indicate they are wired paths (although these paths may be wireless paths, if desired). Communications with the user equipment devices may be provided by one or more of these communications paths, but are shown as a single path in FIG. 12 to avoid overcomplicating the drawing.

Although communications paths are not drawn between user equipment devices, these devices may communicate directly with each other via communication paths, such as those described above in connection with paths 1208, 1210, and 1212, as well other short-range point-to-point communication paths, such as USB cables, IEEE 1394 cables, wireless paths (e.g., Bluetooth, infrared, IEEE 802-11, etc.), or other short-range communication via wired or wireless paths. BLUETOOTH is a certification mark owned by Bluetooth SIG, INC. The user equipment devices may also communicate with each other through an indirect path via communications network 1214.

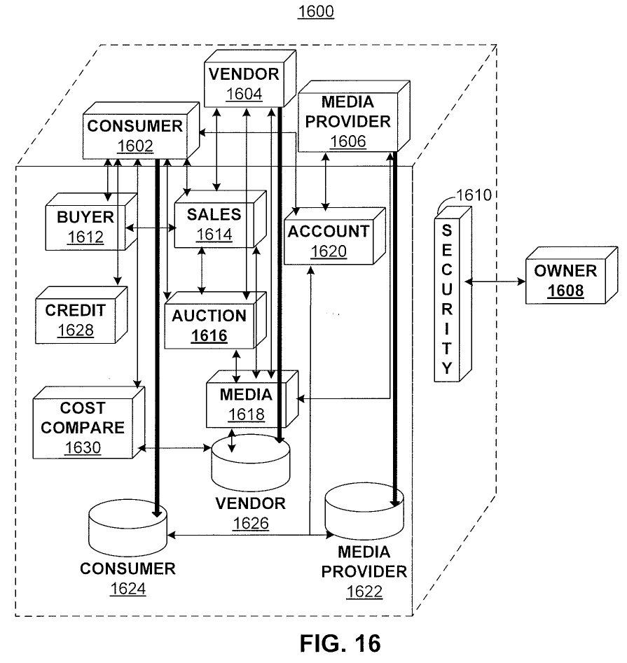

System 1200 includes media content source 1216 and media guidance data source 1218 coupled to communications network 1214 via communication paths 1220 and 1222, respectively. Paths 1220 and 1222 may include any of the communication paths described above in connection with paths 1208, 1210, and 1212. Communications with media content source 1216 and media guidance data source 1218 may be exchanged over one or more communications paths, but are shown as a single path in FIG. 12 to avoid overcomplicating the drawing. In addition, there may be more than one of each of media content source 1216 and media guidance data source 1218, but only one of each is shown in FIG. 12 to avoid overcomplicating the drawing. (The different types of each of these sources are discussed below.) In an embodiment, media guidance data source 1218 may be associated with an owner (discussed in detail below with reference to FIGS. 14 and 16). If desired, media content source 1216 and media guidance data source 1218 may be integrated as one source device. Although communications between sources 1216 and 1218 with user equipment devices 1202, 1204, and 1206 are shown as through communications network 1214, in some embodiments, sources 1216 and 1218 may communicate directly with user equipment devices 1202, 1204, and 1206 via communication paths (not shown) such as those described above in connection with paths 1208, 1210, and 1212.

Media content source 1216 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, print media distributors, radio broadcasters, satellite broadcasters and other media content providers. NBC is a trademark owned by the National Broadcasting Company, Inc., ABC is a trademark owned by the ABC, INC., and HBO is a trademark owned by the Home Box Office, Inc. Media content source 1216 may be the originator of media content (e.g., a television broadcaster, a Webcast provider, etc.) or may not be the originator of media content (e.g., an on-demand media content provider, an Internet provider of video content of broadcast programs for downloading, a distributor of print or electronic books, etc.). Media content source 1216 may include cable sources, satellite providers, on-demand providers, Internet providers, or other providers of media content. Media content source 1216 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media delivery system 1200 may illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 12.

In one approach, user equipment devices may communicate with each other within a consumer's home network. User equipment devices can communicate with each other directly via short-range point-to-point communication schemes describe above, via indirect paths through a hub or other similar device provided on a home network, or via communications network 1214. Each of the multiple individuals in a single home may operate different user equipment devices on the home network. As a result, it may be desirable for various media guidance information or settings to be communicated between the different user equipment devices. For example, it may be desirable for consumers to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content. For example, a user may transmit media content from user computer equipment to a portable video player or portable music player. In an embodiment, media content accessed by a consumer via system 100 may be distributed and/or copied among one or more user equipment devices, with such distribution subject to restriction (e.g., an electronic publication may be accessed by at most three electronic readers).

In a second approach, a consumer may have multiple types of user equipment by which he or she accesses media content and obtains media guidance. For example, some users may have home networks that are accessed by in-home and mobile devices. Consumers may control in-home devices via a media guidance application implemented on a remote device. For example, consumers may access an online media guidance application (which may include account information as discussed above with reference to FIG. 2) on a website via a personal computer at their office, or a mobile device such as a PDA or web-enabled mobile telephone. The consumer may set various settings (e.g., recordings, reminders, or other settings) on the online guidance application to control the user's in-home equipment. The online guide may control user equipment directly, or by communicating with a media guidance application on in-home user equipment. Various systems and methods for user equipment devices communication, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a consumer's home can use their media guidance applications to communicate directly with media content source 1216 to access media content. Specifically, within a home, users of user television equipment 1204 and user computer equipment 1206 may access the media guidance application to navigate among and locate desirable media content. Consumers may also access the media guidance application outside of the home using wireless user communications devices 1206 to navigate among and locate desirable media content.

Media guidance application data may be provided to a user equipment device using any suitable approach. In an embodiment, a guidance application may be a stand-alone interactive program guide that receives program guide data via a data feed (e.g., a continuous feed or a trickle feed). In an embodiment, program schedule data and other guidance data may be provided to user equipment on a television channel sideband, in the vertical blanking interval of a television channel, using an in-band digital signal, using an out-of-band digital signal, or by any other suitable data transmission technique or combination of techniques. Program schedule data and other guidance data may be provided to user equipment on multiple analog or digital channels, such as analog or digital radio and television channels. Program schedule data and other guidance data may be provided to the user equipment with any suitable frequency (e.g., continuously, daily, at a user-specified interval of time, a system-specified period of time, in response to a request from user equipment, etc.). In an embodiment, guidance data from media guidance data source 1218 may be provided to user equipment using a client-server approach. For example, a guidance application client residing on user equipment may initiate sessions with source 1218 to obtain guidance data when needed. Media guidance data source 1218 may provide user equipment devices 1202, 1204, and 1206 with the media guidance application itself and/or software updates for the media guidance application.

Media guidance applications may be, for example, stand-alone applications implemented on user equipment devices. In other embodiments, media guidance applications may be client-server applications where only the client resides on the user equipment device. For example, a media guidance application may be implemented partially as a client application on control circuitry 1104 of user equipment device 1100 and partially on a remote server as a server application (e.g., media guidance data source 1218). Guidance application displays (e.g., the illustrative screens of FIGS. 3, 8, 9 and 13) may be generated by media guidance data source 1218 and transmitted to the user equipment devices. Media guidance data source 1218 may also transmit data for storage on the user equipment, which then may generate the guidance application displays based on instructions processed by control circuitry.

A guidance application may be implemented using any suitable architecture. For example, a guidance application may be a stand-alone application wholly implemented on user equipment device 1100. In such an approach, instructions of the application may be stored locally, and data for use by the application may be downloaded on a periodic basis (e.g., from the VBI of a television channel, from an out-of-band feed, or using another suitable approach). In another embodiment, the media guidance application may be a client-server based application. Data for use by a thick or thin client implemented on user equipment device 1100 may be retrieved on-demand by issuing requests to a server remote to user equipment device 1100. In one example of a client-server based guidance application, control circuitry 1104 may run a web browser that interprets web pages provided by a remote server.

In yet other embodiments, a media guidance application may be downloaded and interpreted or otherwise run by an interpreter or virtual machine (run by control circuitry 1104). In some embodiments, a guidance application may be encoded in the ETV Binary Interchange Format (EBIF), received by control circuitry 1104 as part of a suitable feed, and interpreted by a user agent running on control circuitry 1104. For example, a guidance application may be a EBIF widget. In other embodiments, a guidance application may be defined by a series of JAVA-based files that are received and run by a local virtual machine or other suitable middleware executed by control circuitry 1104. In some of such embodiments (e.g., those employing MPEG-2 or other digital media encoding schemes), a guidance application may be, for example, encoded and transmitted in an MPEG-2 object carousel with the MPEG audio and video packets of a program.

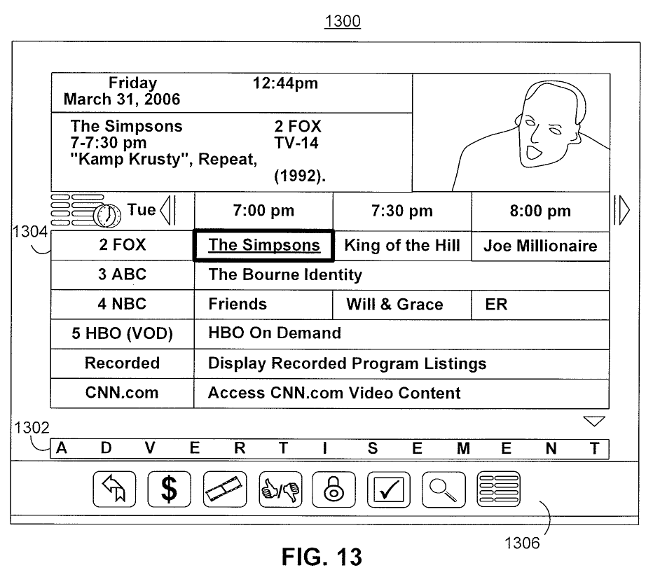

Media guidance applications may be used to provide one or more of media listings, media information, media content, media access and transaction opportunities to users. FIG. 13 depicts an illustrative display screen that may be used to provide media guidance, and in particular media listings. The display screen depicted in FIG. 13 may be implemented on any suitable device or platform. While the display of FIG. 13 is illustrated as a full screen display, information may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to a user's indication, a media guidance application may provide a display screen with media information organized in one of several ways, such as by time and channel in a grid, by time, by channel, by media type (e.g., text, video, audio), by category (e.g., movies, sports, news, children, or other categories of programming), or other predefined, user-defined, or other organization criteria. Such criteria may be specified by a consumer as part of the consumer's information preferences (e.g., as discussed above with reference to FIG. 3).

Media guidance applications may also be used to facilitate transactions between vendors and consumers in system 100 of FIG. 1 as described above (e.g., with reference to FIGS. 2, 3, 8 and 9). For example, a media guidance application may allow a user to configure media access account settings and participate in transactions with vendors to sponsor such media access. Various systems and methods for performing transactions via media access systems are discussed in, for example, Ellis et al., U.S. patent application Ser. No. 09/368,198, filed Aug. 4, 1999, which is hereby incorporated by reference herein in its entirety.

The media information and media access account configuration functions of a media guidance application may be interrelated. For example, advertisement 1302 of FIG. 13 may provide an advertisement for media content that, depending on a consumer's access configuration and/or media access requests (e.g., for subscription programming), is currently available for viewing, will be available for viewing in the future, may be available for viewing if a user obtains sufficient sponsorship, or may never become available for viewing. Advertisement 1302 may correspond to or be unrelated to one or more of the media listings in grid 1304. Advertisement 1302 may also be for products or services related or unrelated to the media content displayed in grid 1304, and provide information or transaction opportunities which may result in transactions that provide vendor sponsorship of media access. Advertisement 1302 may be selectable and provide further information about media content, provide information about a product or a service, enable purchasing of media content, a product, or a service, provide media content relating to the advertisement, etc. Advertisement 1302 may be targeted based on a user's information preferences (e.g., as described above with reference to FIG. 3), a user's profile (e.g., as described above with reference to FIG. 2), monitored user activity, the type of display provided, or on other suitable targeted advertisement bases.

Advertisement 1302 may be a transaction opportunity directed to a particular user or group of users by a vendor. Such a directed transaction opportunity may be based on any of the above targeting factors. In an embodiment, consumer information may be provided to vendors by a buyer module as discussed below.

Options region 1306 may allow the user to access different types of media content, media guidance application displays, and/or media guidance application features. Options region 1306 may be part of display 1300 (and other display screens of the present invention), or may be invoked by a user by selecting an on-screen option or pressing a dedicated or assignable button on a user input device. The selectable options within options region 1306 may concern features related to program listings in grid 1304 and may include options available from a main menu display. Features related to program listings may include searching for other air times or ways of receiving a program, recording a program, enabling series recording of a program, setting program and/or channel as a favorite, purchasing a program, or other features. Options available from a main menu display may include search options (e.g., for media content, transaction opportunities, or both), VOD options, parental control options, access to various types of listing displays, subscribe to a premium service, edit a consumer's account and/or profile, access a browse overlay, or other options.

A media guidance application may be personalized based on a consumer's preferences. A personalized media guidance application allows a consumer to customize displays and features to create a personalized “experience” with the media guidance application. This personalized experience may be created by allowing a consumer to input these customizations and/or by the media guidance application monitoring consumer activity to determine various preferences (e.g., as described above with reference to FIG. 2). Users may access their personalized guidance application by logging in or otherwise identifying themselves to the guidance application. Customization of the media guidance application may be made in accordance with a user profile. The customizations may include varying information format preferences (e.g., as described above with reference to FIG. 3), presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

A media guidance application may allow a consumer to provide consumer profile information (e.g., as described above with reference to FIG. 2) or may automatically compile consumer profile information. The media guidance application may, for example, monitor the media the consumer accesses and/or other interactions the consumer may have with the guidance application. Additionally, the media guidance application may obtain all or part of other profiles that are related to a particular consumer (e.g., from other web sites on the Internet the consumer accesses, such as www.tvguide.com, from other media guidance applications the consumer accesses, from other interactive applications the consumer accesses, from a handheld device of the consumer, etc.), and/or obtain information about the consumer from other sources that the media guidance application may access. As a result, a consumer can be provided with a unified guidance application experience across the consumer's different devices. Additional personalized media guidance application features are described in greater detail in Ellis et al., U.S. patent application Ser. No. 11/179,410, filed Jul. 11, 2005, Boyer et al., U.S. patent application Ser. No. 09/437,304, filed Nov. 9, 1999, and Ellis et al., U.S. patent application Ser. No. 10/105,128, filed Feb. 21, 2002, which are hereby incorporated by reference herein in their entireties.

The consumer may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a consumer sets a channel as a favorite on, for example, the web site www.tvguide.com on their personal computer at their office, the same channel would appear as a favorite on the consumer's in-home devices (e.g., user television equipment 1202 and user computer equipment 1204 of FIG. 12) as well as the consumer's mobile devices, if desired. Therefore, changes made on one user equipment device can change the guidance experience on another user equipment device, regardless of whether they are the same or a different type of user equipment device. In addition, the changes made may be based on settings input by a consumer, as well as consumer activity monitored by the guidance application.

It will be appreciated that while the discussion of media content has focused on video content, the principles of media delivery and guidance can be applied to many types of media content, such as text, music, images, etc. Additionally, the methods and systems described herein readily apply to providing delivery of many types of services, including Internet access and cellular and land-based telephone service.

For illustrative purposes, the methods and systems of vendor-sponsored media access presented herein have largely been described with respect to the block diagram of FIG. 1, in which three participants are included in system 100. The configuration and inclusion of a fourth auxiliary participant is discussed above with reference to FIG. 6. Additionally, configurations with different numbers and types of participants may be desirable in certain applications. In the following embodiments, consumer, vendor and media provider modules may be configured in accordance with any of the embodiments described above (e.g., with reference to system 100 of FIG. 1). In an embodiment, an owner may participate in the system. FIG. 14 is a simplified diagram of an illustrative vendor-sponsored media delivery system 1400 including an owner module 1440. An owner may take on any one or more of the activities required to maintain and operate the systems described herein, including account maintenance, billing, and transaction monitoring.

In an embodiment, a system 1400 for managing vendor-sponsored access to media content may include owner module 1440, which may be in electronic communication with one or more of consumer module 1410, vendor module 1420 and media provider module 1430. These modules may be associated with an owner, a consumer, a vendor and a media provider, respectively. In an embodiment, owner module 1440 may be configured to communicate, instructions to media provider module 1430 to provide access to media content to consumer module 1410. In an embodiment, owner module 1440 may be further configured to receive an electronic communication from vendor module 1420. The electronic communication may indicate a consumer associated with consumer module 1410 and may communicate sponsorship, by the vendor, of a portion of the cost of the media content access provided to consumer module 1410 by media provider module 1430. The electronic communication may be transmitted from vendor module 1420 in response to a transaction between a vendor and a consumer. Owner module 1440 may additionally be configured to maintain a record including the media content access provided to consumer module 1410 by media provider module 1430, and the portion of the cost of the media content access sponsored by the vendor. For example, sponsorship by a vendor may include a payment towards a periodic service cost of the media content access provided to consumer module 1410. Sponsorship by a vendor may include a payment for one or more items of media content provided to consumer module 1410. In an embodiment, consumer module 1410, vendor module 1420, media provider module 1430 and owner module 1440 may be any suitable hardware devices capable of performing the functions described herein (e.g., the devices discussed above with reference to FIGS. 11 and 12).

In an embodiment, an owner may also be a media provider. Additionally, an owner module, such as owner module 1440, may be advantageous in systems which include multiple media providers. In an embodiment, owner module 1440 may be further configured to communicate instruction to multiple media provider modules to provide access to media content to consumer module 1410, and consumer module 1410 may be configured to access media content from the multiple media provider modules.

FIG. 15 is a simplified diagram of an illustrative vendor-sponsored media delivery system 1500 including a buyer module 1540. Illustrative system 1500 also includes consumer module 1510, vendor module 1520, and media provider module 1530, In an embodiment, consumer module 1410, vendor module 1420, media provider module 1430 and buyer module 1540 may be suitable hardware devices capable of performing the functions described herein (e.g., the devices discussed above with reference to FIGS. 11 and 12). Buyer module 1540 may be included in system 1500 to provide a layer of additional security and anonymity in a consumer's access to media content, a consumer's transactions with one or more vendors, or a combination thereof. A buyer module may also be used to provide information regarding a consumer's preferences to a vendor without revealing the consumer's identity, enabling the delivery of more suitable transaction opportunities to the consumer without sacrificing privacy.

In an embodiment, buyer module 1540 may be configured to monitor consumer module 1510 and provide a profile of the consumer based at least in part on the monitoring of consumer module 1510. The consumer profile may not include the identity of the consumer. Consumer profile information provided by buyer module 1540 may be based at least in part on profile information provided by the consumer at step 250 of the flowchart of FIG. 2. In an embodiment, such a consumer profile may be provided by buyer module 1540 to at least one of media provider module 1530 and vendor module 1520. Further, in an embodiment, vendor information content, based at least in part on the consumer profile, is provided to consumer module 1510 by media provider module 1530. Buyer module 1540 may be fully automated, or may function in response to consumer feedback or manual control by a consumer or another managing party.

In an embodiment, a vendor-sponsored media delivery system may include both a buyer module (e.g, buyer module 1540 of FIG. 15) and an owner module (e.g., owner module 1440 of FIG. 14). In such an embodiment, a buyer module may prevent an owner module from knowing the identity of consumers engaged in transactions within the system, while still allowing such transactions to take place. In an embodiment, a trusted set of participants (such as technicians or support providers) may be granted access to the identities of one or more consumers from time to time in order, for example, to maintain and improve the performance of the system.

An embodiment of vendor-sponsored media delivery system 1600 including a buyer module and an owner module is depicted in the simplified block diagram of FIG. 16. System 1600 may enable communication between client or peer systems in consumers' homes, in media providers' head-ends or central offices, and in vendors' data centers. System 1600 may include consumer subsystem 1602, vendor subsystem 1604 and media provider subsystem 1606, which may provide communication interfaces to the three respective participants' systems. Each of subsystems 1602, 1604 and 1606 may include an associated module as described above, which may include any suitable hardware device configured to perform the functions described herein. For example, these subsystems may carry out the configuration of consumers, vendors and media providers (as described above with reference to FIGS. 2, 4 and 5). When high-level functions are needed by more than one of the other subsystems in system 1600, such functions may be handled in one or more of these three components.

FIG. 16 also depicts an owner subsystem 1608. In an embodiment, owner subsystem 1608 may coincide with one or more of vendor subsystem 1604 and media provider subsystem 1606.

In an embodiment, owner subsystem 1608 may access system 1600 under the watch of security subsystem 1610. Security subsystem 1610 may connect, or prohibit connections between, subsystems of system 1600. Individuals associated with owner subsystem 1608, such as employees of a company responsible for owner subsystem 1608, may need a variety of clearances for higher or lower levels of capability according to their job responsibilities. Along such lines, each subsystem of system 1600 may vary in the amount of security required. In order to allow technicians to maintain system 1600, different security keys may be granted (e.g., by an outside service). Additional security features may be implemented in accordance with known secure computing, data transfer and networking techniques.

Buyer subsystem 1612, for example, may require a high level of protection. As introduced above, buyer subsystem 1612 may enable the creation of an anonymous “buyer” persona with a consumer's profile, so vendors may provide the consumers with suitable transaction opportunities without actually knowing their true identity, thus protecting the consumers' privacy.

The arrows in FIG. 16 indicate which other components individual subsystems may work with to accomplish different goals. It will be understood that system 1600 may include suitable working relationships between subsystems not indicated in FIG. 16 to carry out the functions described herein. As depicted in FIG. 16, buyer subsystem 1612 may work with consumer subsystem 1602 and with sales subsystem 1614.

Sales subsystem 1614 may handle shopping by a consumer, or by a “buyer” representing the consumer. Sales subsystem 1614 may be fairly end-to-end, covering needs including browsing for goods and services, providing up-selling and cross-selling, and administering checkout for transactions. Sales subsystem 1614 may be connected to vendor subsystem 1604 and buyer subsystem 1612. Sales subsystem 1614 may also be connected to consumer subsystem 1602, for those consumers who prefer a more direct alternative to the anonymous “buyer” method. In an embodiment, a consumer may specify when a transaction should occur through buyer subsystem 1612.

Sales subsystem 1614 may be connected to media subsystem 1618, which may allow video, audio, text and interactive programming to be used during a transaction. A consumer may inform system 1600 through consumer subsystem 1602 when he or she is willing to review the media coming from sales subsystem 1614. From time to time, account subsystem 1620 might encourage a consumer to shop or engage in a transaction whenever the consumer's account is running low. The connection between consumer subsystem 1602 and sales subsystem 1614 may be used for a consumer to inform system 1600 that a satisfactory fulfillment of a good or service provided by a vendor has occurred, and that the transaction may be finalized (e.g., by recording the satisfactory fulfillment in a database). When that happens, sales subsystem 1614 may communicate to account subsystem 1620 and part of the proceeds from the transaction may be used to sponsor the consumer's media access (e.g., may be applied to the consumer's media access bill). In an embodiment, the communication between sales subsystem 1614 and account subsystem 1620 may take place upon confirmation provided by vendor subsystem 1604 or any other suitable subsystem.

Account subsystem 1620 may track and allow changes to the amount that a consumer owes a media service provider for media access, as well as which services the consumer accesses from the media provider (e.g., as described above with reference to FIG. 7). Account subsystem 1620 may also handle the registration of consumers, vendors, media providers and auxiliary participants (e.g., as described above with reference to FIGS. 2 and 4-6). In an embodiment, there may be a connection between media provider database 1622 and consumer database 1624, which may enable a link between a consumer module and a media provider module as described above. Account subsystem 1620 may maintain the required linking between the two databases. In an embodiment, vendor database 1626 may be independent.

In an embodiment, credit subsystem 1628 may allow an owner to lend money to a consumer. If an owner of system 1600 is a media provider, a loan may take the form of credit against a consumer's media access bill. Alternatively, credit subsystem 1628 may interface to one or more banks, credit card companies or other outside lending institutions.

Auction subsystem 1616 may allow consumers to competitively bid on some of the goods and services provided by vendors. Once the bidding is complete, the sale may be consummated using sales subsystem 1614 as described above. In an embodiment, both consumers and anonymous “buyers” may participate in auctions. In an embodiment, a vendor may not need to know anything about the consumers who are bidding during an auction, and thus vendor subsystem 1604 may not be connected to auction subsystem 1616. In an embodiment, once an auction completes, sales subsystem 1614 may work with the winning consumer. As described above, auction subsystem 1616 may also work “in reverse” by managing proposals from multiple vendors to satisfy a consumer's request for a good or service.

Cost compare subsystem 1630 may identify comparative pricing for similar goods and services when requested by consumers (e.g., as described above with reference to FIG. 8). Cost compare subsystem 1630 may receive information from vendor database 1626. In an embodiment, a vendor may be aware that this type of access will occur before the vendor participates in the system.

Media subsystem 1618 may handle the delivery, removal and distribution of video, audio, text and interactive programming. Media subsystem 1618 may also work as a back-end server for an interactive television or Internet interactive application. Communications for such applications may go through media provider subsystem 1606 when suitable or vendor subsystem 1604 when an alternative may be desired. For example, when a media provider does not handle a consumer's Internet connection, vendor subsystem 1604 may be used for Internet-based shopping. As suitable, content may come from, and be maintained by, a media provider and/or a vendor. In an embodiment, all media may be stored consistently on vendor database 1626 for convenience.

Additional functions, such as those required to maintain accounts and perform activities related to auxiliary participants (e.g., as described above with reference to FIG. 6) may be performed by suitable existing or additional subsystems within system 1600.

It is to be understood that while certain forms of the present invention have been illustrated and described herein, it is not to be limited to the specific forms or arrangement of parts described and shown. Those skilled in the art will know or be able to ascertain, using no more than routine experimentation, many equivalents to the embodiments and practices described herein. Accordingly, it will be understood that the invention is not to be limited to the embodiments disclosed herein.

What is claimed is:

1. An electronic system for managing vendor-sponsored access to media content, comprising:
a consumer device, in electronic communication with a media provider device and configured to:
receive access to electronic media content provided by the media provider device; and
engage in a transaction with a vendor, engaging in a transaction with a vendor comprising:
requesting a transaction opportunity from the media provider device;
receiving one or more transaction opportunities in response to the request; and
selecting a received transaction opportunity, wherein the selected transaction opportunity is associated with the vendor;
wherein engaging in the transaction with the vendor results in sponsorship, by the vendor, of a portion of the cost of the electronic media content access provided to the consumer device by the media provider device.

2. The electronic system of claim 1, wherein the consumer device is further configured to receive vendor information content provided by the media provider device.

3. The electronic system of claim 2, wherein at least some of the vendor information content is provided to the media provider device by a vendor device associated with the vendor.

4. The electronic system of claim 2, wherein the vendor information content includes at least one of a good and a service offered by the vendor for purchase by a consumer associated with the consumer device.

5. The electronic system of claim 2, wherein the vendor information content is provided in response to the transaction opportunity request transmitted to the media provider device by the consumer device.

6. The electronic system of claim 2, wherein the vendor information content is provided based at least in part on a consumer information preference for at least one of traditional commercial advertisements, comparative purchase information, infomercial advertisements, and interactive advertisements.

7. The electronic system of claim 2, wherein the vendor information content is provided based at least in part on a consumer information preference for a transaction opportunity for at least one of a type of good and a type of service.

8. The electronic system of claim 2, wherein the vendor information content comprises vendor information content from multiple vendors, each associated with a vendor device.

9. The electronic system of claim 1, wherein the media provider device is further configured to communicate the selected transaction opportunity to a vendor device associated with the vendor.

10. The electronic system of claim 1, wherein the consumer device is further configured to receive an outstanding cost of the media content access based on a stored record of the media content access provided to the consumer device and a history of transactions with one or more vendors.

11. The electronic system of claim 10, wherein the media content access provided to the consumer device may be adjusted based at least in part on the outstanding cost.

12. The electronic system of claim 1, further comprising:
a buyer device, configured to monitor the consumer device and provide a profile of an associated consumer based at least in part on the monitoring of the consumer device, wherein the consumer profile does not include the identity of the associated consumer.

13. The electronic system of claim 12, wherein the consumer profile is provided to at least one of the media provider device and a vendor device associated with the vendor.

14. The electronic system of claim 12, wherein vendor information content, based at least in part on the consumer profile, is provided to the consumer device by the media provider device.

15. The electronic system of claim 1, wherein sponsorship, by the vendor, comprises a payment towards a periodic service cost of the electronic media content access provided to the consumer device.

16. The electronic system of claim 1, wherein sponsorship, by the vendor, comprises a payment for one or more items of media content provided to the consumer device.

17. An electronic system for managing vendor-sponsored access to media content, comprising:
a consumer device, in electronic communication with a media provider device and an owner device and configured to:
receive access to electronic media content provided by the media provider device; and
engage in a transaction with a vendor, engaging in a transaction with a vendor comprising:
requesting a transaction opportunity from the owner device;
receiving one or more transaction opportunities in response to the request; and
selecting a received transaction opportunity, wherein the selected transaction opportunity is associated with the vendor;
wherein engaging in the transaction with the vendor results in sponsorship, by the vendor, of a portion of the cost of the electronic media content access provided to the consumer device by the media provider device.

18. The electronic system of claim 17, wherein the owner device is configured to communicate, to the media provider device, instructions to provide access to media content to the consumer device.

19. The electronic system of claim 17, wherein the owner device is configured to receive a communication, from a vendor device associated with the vendor, representative of the vendor sponsorship.

20. The electronic system of claim 17, wherein the owner device is configured to maintain a record including the media content access provided to the consumer device by the media provider device, and the portion of the cost of the media content access sponsored by the vendor.
